(19) United States
(12) Patent Application Publication
(10) Pub. No.: US 2016/0110199 A1
(43) Pub. Date: Apr. 21, 2016

(54) DEVICE AND METHOD FOR PROCESSING COUNTER DATA

(71) Applicant: SAMSUNG ELECTRONICS CO., LTD., Suwon-si (KR)

(72) Inventors: Junkyoung KIM, Suwon-si (KR); Soojung RYU, Hwaseong-si (KR)

(73) Assignee: SAMSUNG ELECTRONICS CO., LTD., Suwon-si (KR)

(21) Appl. No.: 14/713,616

(22) Filed: May 15, 2015

(30) Foreign Application Priority Data
Oct. 21, 2014 (KR) 10-2014-0142770

(51) Int. Cl. G06F 9/32; G06F 9/38; G06F 9/44

(52) U.S. Cl. CPC G06F 9/321; G06F 9/444; G06F 9/3844; G06F 9/3863

(57) ABSTRACT

Provided are a device and a method of processing counter data, the method including receiving pieces of state data and counter data which is a transition condition between the pieces of state data, the pieces of state data and the counter data being expressed as a state machine, determining whether or not the counter data is generated based on the state machine, storing state data, which is transitioned from the counter data in response to the generation of the counter data, and outputting the stored state data.

### CROSS-REFERENCE TO RELATED APPLICATION

This application claims the benefit under 35 USC 119(a) of Korean Patent Application No. 10-2014-0142770, filed on Oct. 21, 2014, in the Korean Intellectual Property Office, the disclosure of which is incorporated herein by reference for all purposes.

### BACKGROUND

1. Field

The following description relates to a method and device for processing counter data.

2. Description of Related Art

A chip or system has a counter to show an operational characteristic. Accordingly, a user uses counter data provided by the system in order to analyze the performance or characteristic of the system. Generally, a system includes a buffer to store counter data generated in the system. However, because of a very large amount of counter data generated in the system, the system occasionally stops operations in order to empty the buffer storing counter data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional aspects will be set forth in part in the description which follows and, in part, will be apparent from the description, or may be learned by practice of the presented embodiments.

According to an aspect of an embodiment, a method of processing counter data includes receiving pieces of state data and the counter data, which is a transition condition between the pieces of state data, the pieces of state data and the counter data being expressed as a state machine, determining whether or not the counter data is generated based on the state machine, storing state data, which is transitioned from the counter data, in response to the generation of the counter data, and outputting the stored state data.

The method may further include determining whether or not first counter data, which is a condition for transitioning from a first state data, is generated among the counter data, based on the first state data from among the pieces of state data, storing second state data, which is transitioned from the first state data, in response to the generation of the first counter data, and outputting the stored second state data.

The method may further include in response to the second state data being stored because of the generation of the first counter data, determining whether or not second counter data, which is a condition for transitioning from the second state data, is generated among the counter data, based on the second state data, storing third state data, which is transitioned from the second counter data, in response to the generation of the second counter data, and outputting the stored second state data and the third state data.

The method may further include storing information on a time point when the state data transitioned by the generation of the counter data, and when the stored data is output, the information on the time point is output.

The method may further include transforming the state machine by determining a predetermined number of state data from among the pieces of state data, as macro state data.

The method may further include storing state data transitioned by the generation of counter data in the transformed state machine based on the transformed state machine, and transforming the macro state data into the predetermined number of state data in response to the macro state data being included in the stored state data.

The method may further include transforming the state machine into a first state machine by determining a predetermined number of state data from among the pieces of state data, as first macro state data, storing state data transitioned by the generation of counter data in the first state machine based on the first state machine, transforming the state machine into a second state machine by determining another predetermined number of state data from among the pieces of state data, as second macro state data, storing state data transitioned by the generation of counter data in the second state machine based on the second state machine; transforming the first macro state data or the second macro state data into the predetermined number of state data or the another predetermined number of state data in response to the first macro state data or the second macro state data being included in the state data stored based on the first state machine and the state data stored based on the second state machine, and outputting the transformed state data.

The method may further include in the storing of the state data, the transitioned state data is stored in order of transition by the generation of the counter data.

The method may further include the pieces of state data and the counter data that is a transition condition between the pieces of state data, expressed as the state machine, are determined by a user's setting.

According to an aspect, a device for processing counter data includes a state information receiver configured to receive pieces of state data and the counter data, which is a transition condition between the pieces of state data, the pieces of state data and the counter data being expressed as a state machine, a processor, based on the state machine, configured to determine whether or not the counter data is generated, a state buffer, when the counter data is generated, configured to store state data transitioned by the generation of the counter data, and an output unit configured to output the stored state data.

The processor may further be configured to determine whether or not first counter data, which is a condition for transitioning from the first state data, is generated among the counter data based on first state data from among the pieces of state data, and the state buffer may be further configured to store second state data, which is transitioned from the first state data by the generation of the first counter data, in response to the generation of the first counter data, and the output unit may be further configured to output the stored second state data.

The processor may be further configured to determine, based on the second state data, whether or not second counter data, which is a condition for transitioning from the second state data, is generated among the counter data in response to storing the second state data because of the generation of the first counter data, and the state buffer may be further configured to store third state data, which is transitioned from the second counter data by the generation of the second counter data, in response to the generation of the second counter data, and the output unit may be further configured to output the stored second state data and the third state data.

The state buffer may be further configured to store information on a time point when the state data transitioned by the generation of the counter data, and the output unit outputs the stored information on the time point.

The device may further include a macro state processor configured to transform the state machine by determining a predetermined number of state data from among the pieces of state data, as macro state data.

The state buffer may be further configured to store, based on the transformed state machine, state data transitioned by the generation of counter data in the transformed state machine, and the macro state processor may be further configured to transform the macro state data into the predetermined number of state data in response to the macro state data being included in the stored state data.

The macro state processor may be further configured to transform the state machine into a first state machine by determining a predetermined number of state data from among the pieces of state data, as first macro state data, and to transform the state machine into a second state machine by determining another predetermined number of state data from among the pieces of state data, as a second macro state data, and the state buffer may be further configured to store state data transitioned by the generation of counter data in the first state machine based on the first state machine, and the state buffer may be further configured to store state data transitioned by the generation of counter data in the second state machine based on the second state machine, and the macro state processor may be further configured to transform the first macro state data or the second macro state data into the predetermined number of state data or the another predetermined number of state data, in response to the first macro state data or the second macro state data being included in the state data stored based on the first state machine and the state data stored based on the second state machine, and the output unit may be further configured to output the transformed state data.

The state buffer may be further configured to store the transitioned state data in order of transition by the generation of the counter data.

The pieces of state data and the counter data that is a transition condition between the pieces of state data, expressed as the state machine, may be determined by a user's setting.

According to another aspect, a counter data processing device includes a state information receiver configured to receive state data and counter data, a processor configured to determine whether or not the counter data for transitioning from the received state data to another state data is generated, a state buffer configured to store the another state data in response to the generation of the counter data, and an output unit configured to output the stored another state data.

### BRIEF DESCRIPTION OF THE DRAWINGS

FIG. 1 is a diagram illustrating an example of a device;

FIG. 2 is a diagram illustrating an example of a state machine and a state transition table;

FIG. 3 is a diagram illustrating an example of a state buffer;

FIG. 4 is a diagram illustrating an example of a processor shown in FIG. 1;

FIG. 5 is a diagram illustrating an example of a processor shown in FIG. 4;

FIG. 6 is a diagram illustrating an example of another device;

FIGS. 7 through 10 are diagrams illustrating an example of a macro state processor shown in FIG. 6; and

FIG. 11 is a flowchart illustrating an example of a method for processing counter data by a device.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or methods described herein will be apparent to one of ordinary skill in the art. For example, the sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

The terms used in the present embodiments are selected from the terms commonly used at present with considering functions in the present specification, but this may change according to the intention of those skilled in the art or court decisions, or appearance of new technologies.

It will be understood that the terms “comprises” and/or “comprising”, when used in this specification, do not preclude the presence or addition of one or more other features unless otherwise described. Also, the terms such as “ . . . unit” and “ . . . module” indicate a unit for processing at least one function or operation and this unit may be implemented by hardware or software or combination of hardware and software.

In the specification, when a part is “connected” to another part, this indicates not only “directly connected” but also “electrically connected” with other devices in between.

The present embodiments will now be described more fully with reference to the accompanying drawings.

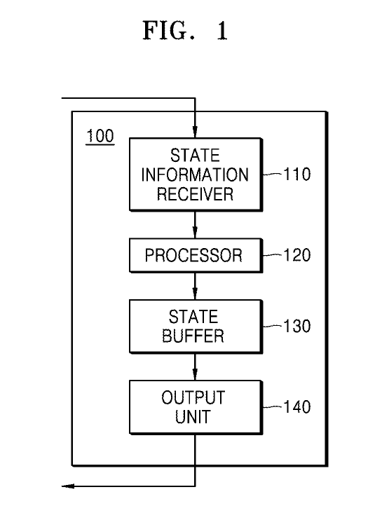

FIG. 1 is a diagram illustrating an example of a device.

The device 100 of FIG. 1 includes a state information receiver 110, a processor 120, a state buffer 130 and an output unit 140 according to an example. Although FIG. 1 illustrates the state information receiver 110, the processor 120, the state buffer 130 and the output unit 140 as being included in the device 100, the state information receiver 110, the processor 120, the state buffer 130 and the output unit 140 may be embedded as independent hardware and thus the device 100 may include more or less elements.

Only those elements related to the present embodiment are shown in the device 100 shown in FIG. 1. Accordingly, one of ordinary skill in the art can understand that other general purpose elements can be further included in addition to the elements shown in FIG. 1.

According to an embodiment, the state information receiver 110 may receive information on pieces of state data and counter data which is a transition condition between the pieces of state data. According to an embodiment, the state information receiver 110 may receive pieces of state data and counter data which is a transition condition between the pieces of state data, the pieces of state data and the counter data being expressed as a state machine.

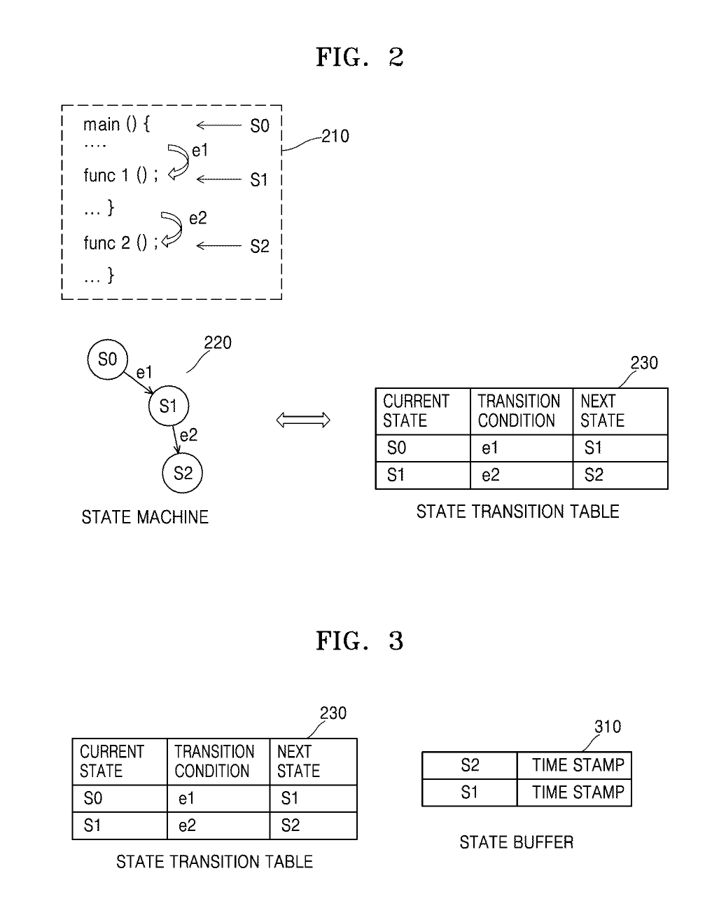

According to an embodiment, a state machine expressed with state data and counter data may be set by a user. A state machine refers to a calculation model formed with a plurality of states and transitions between states in order to design a sequential logic circuit or computer program. Counter data is data related to the count of hardware related activities. Also, according to an embodiment, the counter may be a hardware performance counter or a program counter. According to an embodiment, the user may set an operational characteristic of the device 100 that the user wants, as state data or a transition between state data. Also, the user may set a predetermined number of counter data or predetermined counter data among a plurality of counter data occurring in the device 100, as a condition for a transition between state data. A plurality of counter data occurring in the device 100 include counter data of different types or counter data having different values occurring in the device 100. According to an embodiment, the state machine may be expressed as a state transition table. FIG. 2 will now be explained as an example.

FIG. 2 is a diagram illustrating an example of a state machine and a state transition table.

A code 210 is an example showing that a program is executed in a device 100. That is, the device 100 may execute functions, starting from a main function through a function func 1 to a function func 2. When the code 210 is executed line by line, a program counter may increase sequentially. The program counter indicates an address value for executing a program. Accordingly, while the main function is being executed, the program counter sequentially increases, and when the program counter is e1, the function func 1 is executed. The program counter sequentially increases again, and when the program counter is e2, the function func 2 is executed. Accordingly, if the operational characteristics of the device 100 that the user wants are the main function, the function func 1 and the function func 2, the user may set the main function as state data S0, the function func 1 as state data S1, and the function func 2 as state data S2. Also, the user may set counter data e1 as a condition for transition from state data S0 to state data S1, and set counter data e2 as a condition for transition from state data S1 to state data S2.

Accordingly, the user may set a state machine 220 with the states and transition conditions that are set through the code 210. The state information receiver 110 may receive from the user the state machine 220 set by the user. Also, according to an embodiment, the user may set a state transition table 230 with the states and transition conditions set in the code 210 and the state information receiver 110 may receive from the user the state transition table 230 set by the user. Accordingly, both the state machine 220 and the state transition table 230 shown in FIG. 2 indicate the counter data e1 as a condition for transition from the state data S0 in a current state data to the next state data S1 and the counter data e2 as a condition for transition from the state data S1 in a current state data to the next state data S2. Accordingly, the state machine 220 and the state transition table 230 may be in a corresponding relation.

Also, according to an embodiment, the state information receiver 110 may directly download the state machine 220 or the state transition table 230 from the user, or may receive the state machine 220 or the state transition table 230 from the outside by a communication unit (not shown), or may obtain the state machine 220 or the state transition table 230 from a memory (not shown) inside the device 100.

Also, according to an embodiment, the state information receiver 110 may receive state data S0, S1, and S2 as state data ‘00’, ‘01’, and ‘10’. That is, according to the number of states defined by the user, the number of digits of the bits of state data.

Also, according to an embodiment, when information on state data and counter data which is a transition condition between state data is received, the state information receiver 110 may generate a state transition table or a state machine with the received information.

The processor 120 of FIG. 1 may determine, based on the state transition table or state machine received by the state information receiver 110, whether or not counter data as a transition condition is generated among a plurality of counter data generated in the device 100. For convenience of explanation, hereinafter, even if only a state transition table or a state machine is mentioned, it will be understood as both are mentioned. Accordingly, when a state transition table is mentioned, a state machine is deemed to be also included. According to an embodiment, the processor 120 may determine, based on a state transition table, whether or not counter data for transitioning state data in a current state data is generated among a plurality of counter data.

The state transition table 230 of FIG. 2 will now be explained as an example assuming that state data in a current state data is S0. When counter data is generated in the device 100, the processor 120 may determine whether or not counter data e1 for transitioning from the state data S0 in a current state data is generated. When the counter data e1 is generated, the processor 120 may update the state data S0 in a current state data into the next state data S1. Then, the processor 120 may determine whether or not counter data e2 for transitioning from the state data S1 in a current state data is generated, and when the counter data e2 is generated, the processor 120 may update the state data S1 in a current state data into the next state data S2.

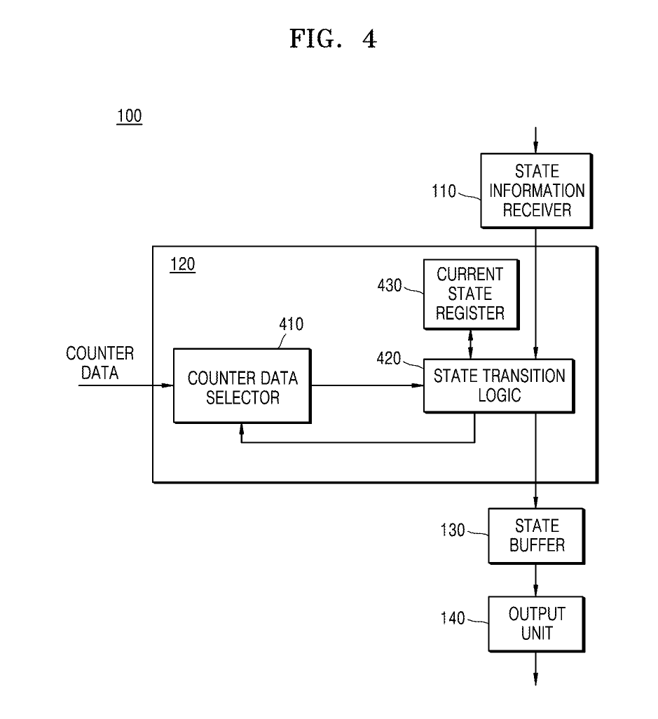

According to an embodiment, when counter data is generated as a transition condition, the state buffer 130 of FIG. 1 may store the state data transitioned by the generation of the counter data. That is, when it is determined by the processor 120 that counter data for transitioning from state data in a current state data is generated, the state buffer 130 may store the next state data transitioned from the state data in a current state data. Also, in addition to the next state data, the state buffer 130 may additionally store information on the time the state data in a current state data is transitioned to the next state data. FIG. 3 will now be explained in detail as an example.

FIG. 3 is a diagram illustrating an example of a state buffer.

A state information receiver 110 may receive a state transition table 230. A processor 120 may determine whether or not counter data e1 for transitioning the state data S0 in a current state data is generated among a plurality of counter data generated in the device 100. When the processor 120 determines that the counter data e1 is generated, the state buffer 310 may store the state data S1 transitioned by the generation of the counter data e1. Also, according to an embodiment, the state buffer 130 may store as a time stamp, information on the time the state data S0 is transitioned to the state data S1. According to an embodiment, the time stamp may be expressed with 32 bits.

Then, the processor 120 may determine whether or not counter data e2 for transitioning from the state data S1 in a current state data is generated. Accordingly, when the processor 120 determines that the counter data e2 is generated, the state buffer 130 may store the state data S2 transitioned by the generation of the counter data e2. Also, the state buffer 130 may store as a time stamp, information on the time the state data S1 is transitioned to the state data S2.

Accordingly, whenever state data is transitioned by the generation of counter data as a transition condition, the state buffer 130 may store the transitioned state data in order of transition.

The output unit 140 of FIG. 1 may output the state data stored in the state buffer 130. Also, according to an embodiment, in addition to the state data stored in the state buffer 130, the output unit 140 may output together information on the time the state data stored in the state buffer 130 was transitioned. Also, when an operation of the device 100 is finished or when the state buffer 130 is filled up with the state data, the output unit 140 may output the state data stored in the state buffer 130.

Accordingly, the user may obtain information on the time period predetermined state data lasts or information on the number of times predetermined state data is performed, by analyzing the output state data or the information on the transition time points. Also, instead of storing in a buffer a very large amount of counter data generated in the device 100, the device 100 stores in the buffer only transitioned state data among pieces of state data set by a user such that the amount of data to be buffered can be reduced.

Also, according to an embodiment, the user may set a state machine related to the operational characteristics of the device 100 and a system including the device 100, and may analyze the operational characteristics of the device 100 and the system including the device 100. Accordingly, the device according to the embodiment may be used in profiling or debugging.

Also, according to an embodiment, the device 100 may use state data stored in the state buffer 130 to control the device 100. For example, by using the state data stored in the state buffer 130, the device 100 may perform setting priorities or branch prediction when a new processing element is scheduled in the device 100.

FIG. 4 is a diagram illustrating an example of a processor shown in FIG. 1.

The processor 120 includes a counter data selector 410, a state transition logic 420 and a current state register 430. Although FIG. 4 illustrates the counter data selector 410, the state transition logic 420 and the current state register 430 as being included in the processor 120, the counter data selector 410, the state transition logic 420 and the current state register 430 may be embedded as independent hardware and thus the processor 120 may include more or less elements.

According to an embodiment, the counter data selector 410 receives a plurality of counter data occurring in the device 100, and may select counter data for transitioning from state data in a current state data among the plurality of counter data. The counter data selector 410 may receive from the state transition logic 420, information on counter data for transitioning from state data in a current state data. When counter data for transitioning from state data in a current state data is generated among the plurality of counter data occurring in the device 100, the counter data selector 410 may transmit information on the generated counter data to the state transition logic 420.

According to an embodiment, the state transition logic 420 may receive information on a state transition table from the state information receiver 110. Also, the state transition logic 420 may recognize state data in a current state data stored in the current state register 430. Accordingly, based on the state transition table and the state data in a current state data, the state transition logic 420 may recognize counter data for transitioning from the state data in a current state data and may transmit the recognized counter data to the counter data selector 410.

Also, the state transition logic 420 may receive counter data for transitioning from the state data in a current state data from the counter data selector 410. Based on the received counter data and the state transition table, the state transition logic 420 may update the state data in a current state data stored in the current state register 430 with the next state data transitioned by the counter data, and store the updated state data. Also, the state transition logic 420 may make the state buffer 420 store the transitioned next state data. Also, the state transition logic 420 may transmit counter data for transitioning from the next state data stored in the current state register 430 to the counter data selector 410.

The current state register 430 may store state data in a current state data. That is, the current state register 430 may store the state data in a current state data as the state data in a current state data, and when the state data in a current state data is updated with a next state data by the state transition logic 420, the current state register 430 may store the next state data as the state data in a current state data. Whenever updating by the state transition logic 420 is repeated, the current state register 430 may store the updated state data as the state data in a current state data.

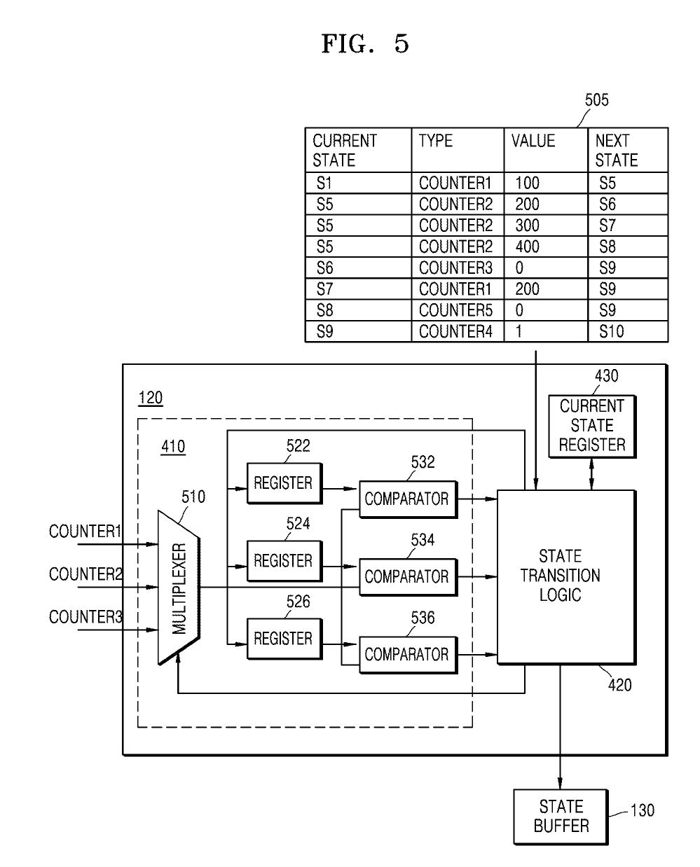

FIG. 5 is a diagram illustrating an example of a processor shown in FIG. 4.

According to an embodiment, the counter data selector 410 of FIG. 4 may include a multiplexer 510, three registers 522, 524 and 526, and three comparators 532, 534 and 536. However, the number of counter data received by the multiplexer 510, the number of registers 522, 524, and 526, and the number of comparators 532, 534, and 536 are not limited by the drawing. As shown in FIG. 5, the state transition logic 420 receives a state transition table 505. Also, at a current point of time, the current state register 430 stores state data S5 as the state data in a current state data.

According to an embodiment, the state transition logic 420 may recognize based on the state transition table 505, counter2 which is a type of counter data for transitioning from state data S5 in a current state data. Also, the state transition logic 420 may transmit the recognized information on counter2 to the multiplexer 510. Accordingly, the multiplexer 510 may select counter2 received from the state transition logic 420 among a plurality of counter data occurring the device 100 (counter1, counter2 and counter3 according to the drawing). Also, the multiplexer 510 may input the selected counter2 into each of the three comparators 532, 534 and 536.

Also, based on the state transition table 505, the state transition logic 420 may input 100, 200 and 300 which are counter2 values for transitioning from the state data S5 in a current state data, into each of the three registers 522, 524, and 526.

Accordingly, the three comparators 532, 534 and 536 may determine whether or not the value input from the register to each comparator is identical to the value from the multiplexer 510, and, if the values are identical, may transmit to the state transition logic 420, information on which value is identical. According to an embodiment, if the value of the counter data counter2 transmitted from the multiplexer 510 is 200, the comparator 534 among the three comparators 532, 534, and 536 may transmit information on the counter data counter2 having a value 200 to the state transition logic 420. Accordingly, based on the state transition table 505 and the counter data counter2 having a value 200, the state transition logic 420 may store the next state data S7 transitioned from the state data S5 in a current state data in the current state register 430. That is, the current state register 430 may update the state data S5, which is currently stored, with the state data S7 received from the state transition logic 420, and store the state data after the update. Also, when the state data S5 is transitioned to the state data S7, the state buffer 130 may store the state data S7.

Then, the state transition logic 420 may recognize counter1 which is counter data type for transitioning from the state data S7 in a current state data, and transmit to the multiplexer 510. Also, based on the state transition table 505, the state transition logic 420 may input 200, which is the value of counter1 for transitioning from the state data S7 in a current state data, to any one of the three registers 522, 524, and 526. Accordingly, by repeating the embodiment explained above, the state data stored in the current state register may be repeatedly updated and the state buffer 130 may sequentially store the transitioned state data.

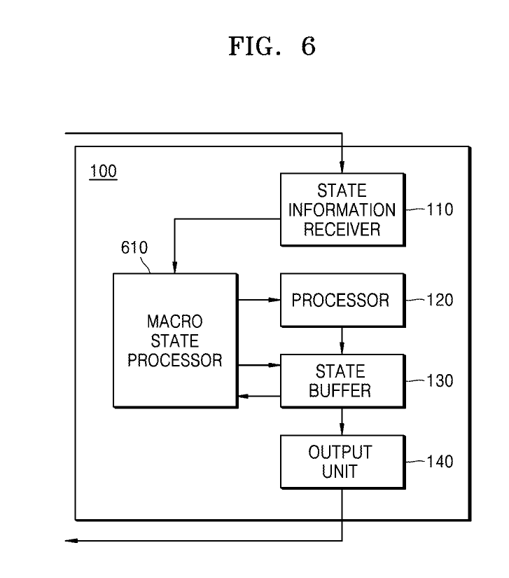

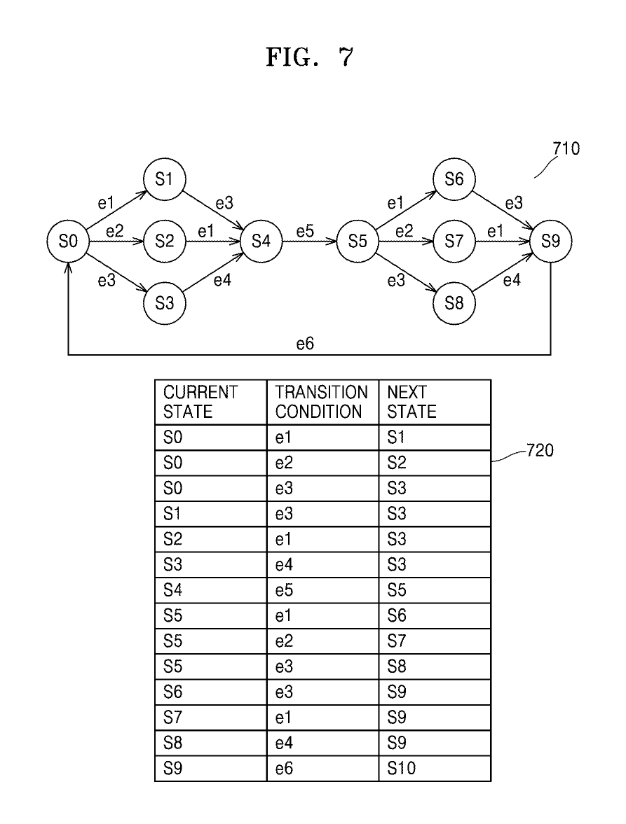

FIG. 6 is a diagram illustrating an example of another device.

The device 100 may further include a macro state processor 610 in addition to the state information receiver 110, the processor 120, the state buffer 130 and the output unit 140 shown in FIG. 1. The explanation on the state information receiver 110, the processor 120 and the state buffer 130 are the same as those in FIG. 1 and will be omitted here.

The macro state processor 610 may receive a state machine set by a user from the state information receiver 110. The macro state processor 610 may transform the received state machine, by determining a predetermined number of state data or predetermined state data among the pieces of state data occurring in the received state machine, as macro state data. That is, the macro state processor 610 may reset the state data occurring in the state machine as macro state data. Also, the macro state processor 610 may transmit the transformed state machine to the processor 120. According to an embodiment, when the amount of data of the state machine set by the user is greater than the amount of data the processor 120 is capable of processing, the macro state processor 610 may reduce the amount of data of the state machine set by the user, by determining the state data occurring in the state machine as macro state data. Also, though it is shown in the drawing that the state machine from the state information receiver 100 is received by the macro state processor 610, it is also possible that the macro state processor 610 receives firstly the state machine and transforms the state machine, and then, the state information receiver 110 receives the transformed state machine. When the state information receiver 110 receives the transformed state machine, the state information receiver 110 transmits the transformed state machine to the processor 120. Also, the macro state processor 610 may be implemented as software as well as hardware.

Based on the transformed state machine, the processor 120 may determine whether or not counter data occurring in the transformed state machine is generated. Also, the state buffer 130 may store state data transitioned by the generation of the counter data.

Additionally, when preset macro state data is included in the state data stored in the state buffer 130, the macro state processor 610 may transform the macro state data into the state data included in the original state machine. That is, when the macro state processor 610 resets a predetermined number of state data included in the state machine set by the user as macro state data and then, the macro state data is stored in the state buffer 130, the macro state data may be again transformed back to the predetermined number of state data.

According to an embodiment, the macro state processor 610 may transform the received state machine into a first state machine, by setting a predetermined number of state data among the state of the received state machine as first macro state, and may transform the received state machine into a second state machine, by setting another predetermined number of state data among the state of the received state machine as second macro state. According to an embodiment, the macro state processor 610 may transform the received state machine into a third state machine, a fourth state machine, and so on. Based on the first state machine, the state buffer 130 may store state data transitioned by the generation of counter data occurring in the first state machine, and based on the second state machine, the state buffer 130 may store state data transitioned by the generation of the counter data occurring in the second state machine. Also, the state buffer 130 may transmit to the macro state processor 610 the state data stored based on the first state machine and the state data stored based on the second state machine. Then, when the first macro state data or the second macro state data is included in the state data stored based on the first state machine and the state data stored based on the second state machine, the macro state processor 610 may transform the first macro state data or the second macro state data into the state data of the state machine received by the state information receiver 110. Accordingly, the state buffer 130 may receive the transformed state data and the output unit 140 may output the transformed state data. Examples will now be explained in detail with reference to FIGS. 7 through 10.

FIGS. 7 through 10 are diagrams illustrating an example of a macro state processor shown in FIG. 6.

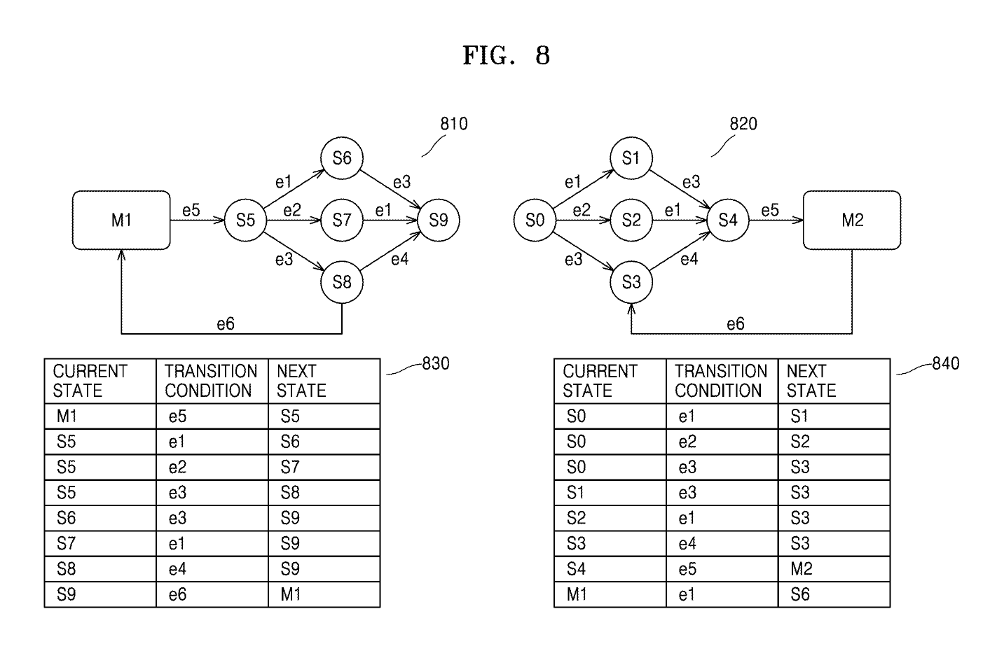

The macro state processor 610 of FIG. 6 may receive a state machine 710 from the state information receiver 110. The state machine 710 may be expressed as a state transition table 720. The macro state processor 610 may transform the received state machine 710 into a first state machine 810 and a second state machine 820 shown in FIG. 8. That is, the macro state processor 610 may transform the state machine 710 into the first state machine 810, by setting state data S0, S1, S2, S3, and S4 included in the state machine 710 as macro state data M1. Also, the macro state processor 610 may transform the state machine 710 into the second state machine 820, by setting state data S5, S6, S7, S8 and S9 included in the state machine 710 as macro state data M2. The state machine 810 may be expressed as a state transition table 830 and the state machine 820 may be expressed as a state transition table 840.

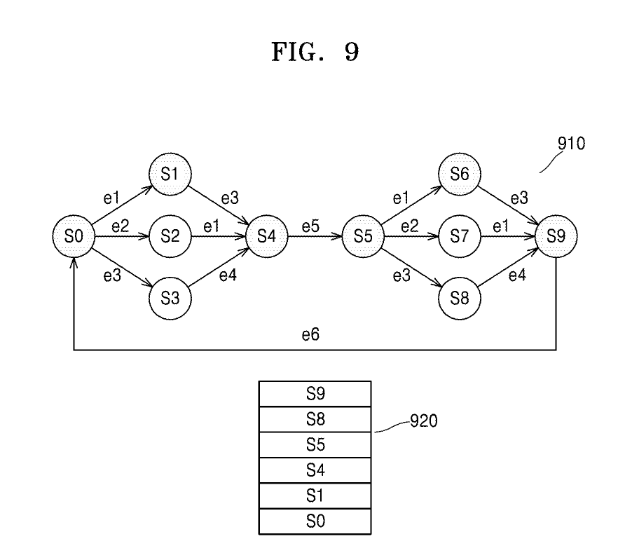

According to an embodiment, as shown in FIG. 9, the processor 120 may receive the state machine of FIG. 7, and based on the state data S0 in a current state data, the processor 120 may determine that counter data e1, e3, e5, e3, and e4 are sequentially generated as shown in 910. Accordingly, the state buffer 130 may sequentially store the state data S0, S1, S4, S5, S8 and S9 as the state buffer 920.

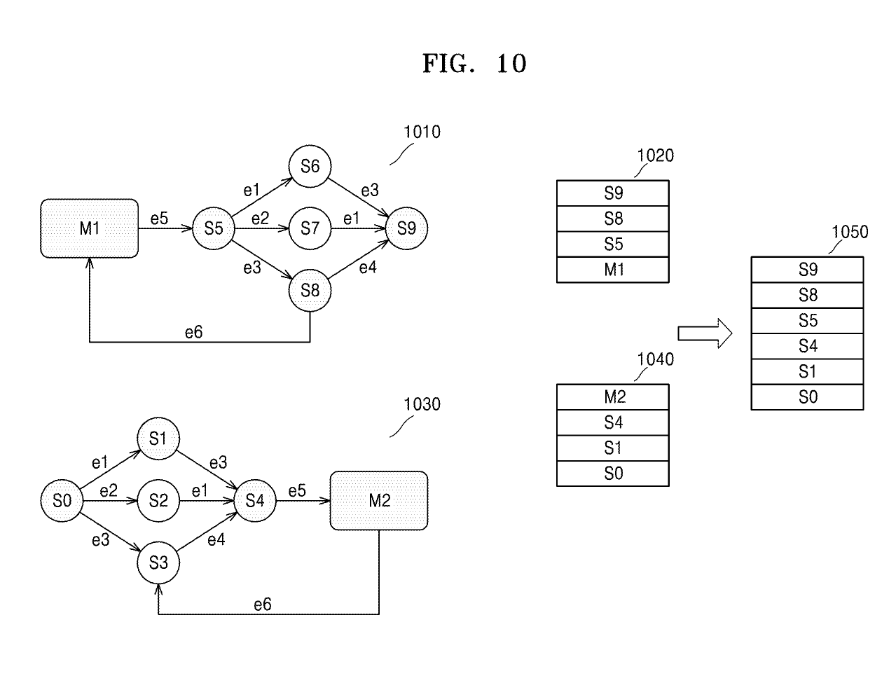

Also, as shown in FIG. 10, the processor 120 may receive the first state machine of FIG. 8, and based on the state data M1 in a current state data, the processor 120 may determine as in FIG. 9 that counter data e1, e3, e5, e3, and e4 are sequentially generated as shown in 1010. Accordingly, the state buffer 130 may sequentially store state data M1, S5, S8, and S9 as the state buffer 1020. Also, the processor 120 may receive the second state machine 820 of FIG. 8 and based on the state data S0 in a current, the processor 120 may determine that counter data e1, e3, e5, e3, and e4 are sequentially generated as in FIG. 9 as shown in 1030. Accordingly, the state buffer 130 may sequentially store the state data S0, S1, S4, and M2 as the state buffer 1020.

Then, when the state buffer 1020 and 1040 includes the macro state data M1 or M2, the macro state processor 610 may transform the macro state data M1 or M2 into the state data of the state machine 710, by using the state buffer 1020 and 1040. That is, the macro state processor 610 may transform the state buffer 1020 and 1040 as the state buffer 1050, and the state buffer 130 may sequentially store the state data S0, S1, S4, S5, S8, and S9 as the state buffer 1050. As a result, the macro state processor 610 may transform the state buffer 1020 and 1040 into a state buffer as same as the state buffer 920 of FIG. 9.

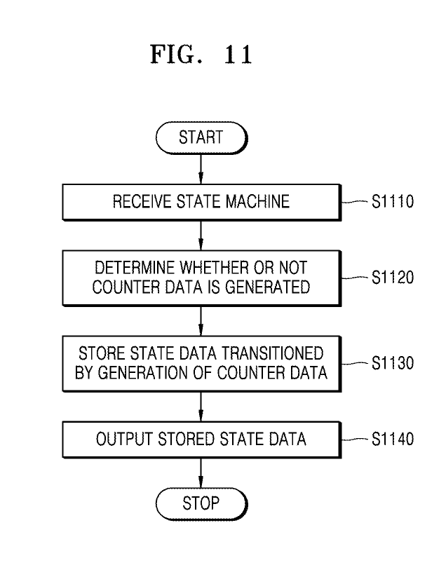

FIG. 11 is a flowchart illustrating an example of a method for processing counter data by a device.

In operation S1110, the device 100 may receive state data expressed as a state machine and counter data that are transition conditions between state data. According to an embodiment, the state machine expressed with the state data and counter data may be set by a user. Also, the user may set a predetermined number of counter data among a plurality of counter data occurring in the device 100, as a condition for a transition between state data. According to an embodiment, the state machine may be expressed as a state transition table.

In operation S1120, based on the received state machine, the device 100 may determine whether or not counter data which is a transition condition of the state machine is generated among a plurality of counter data occurring in the device 100. In detail, based on first state data among the state data occurring in the state machine, the device 100 may determine whether or not counter data which is a transition condition from the first state data to second state data is generated among a plurality of counter data occurring in the device 100.

In operation S1130, when it is determined in operation S1120 that the counter data is generated, the device 100 may store the state data transitioned by the generation of the counter data. That is, the device 100 may store the second state data transitioned from the first state data by the counter data.

Also, whenever state data is transitioned by the generation of counter data as a transition condition, the device 100 may store the transitioned state data in order of transition. Also, the device may additionally store information on the time point the first state data is transitioned to the second state data.

In operation S1140, the device 100 may output the state data stored in the operation S1130. Also, the device 100 may output the information on the transition time points of the state data stored in the operation S1130. When the operation of the device 100 is finished or when the stored state data exceeds the capacity of the state buffer included in the device 100, the device 100 may output the stored state data.

The device described herein may comprise a processor, a memory for storing program data and executing it, a permanent storage such as a disk drive, a communications port for handling communications with external devices, and user interface devices, including a display, keys, etc. When software modules are involved, these software modules may be stored as program instructions or computer readable codes executable on the processor on a non-transitory computer-readable media such as read-only memory (ROM), random-access memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. This media can be read by the computer, stored in the memory, and executed by the processor.

The present disclosure may be described in terms of functional block components and various processing steps. Such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, where the elements are implemented using software programming or software elements the disclosure may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present disclosure could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the disclosure and are not intended to otherwise limit the scope of the disclosure in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent functional relationships and/or physical or logical couplings between the various elements. It should be noted that many alternative or additional functional relationships, physical connections or logical connections may be present in a practical device.

The use of the terms “a” and “an” and “the” and similar referents in the context of describing the disclosure (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or language (e.g., “such as”) provided herein, is intended merely to better illuminate the disclosure and does not pose a limitation on the scope of the disclosure unless otherwise claimed. Numerous modifications and adaptations will be readily apparent to those skilled in this art without departing from the spirit and scope.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of processing counter data, the method comprising:
receiving pieces of state data and the counter data, which is a transition condition between the pieces of state data, the pieces of state data and the counter data being expressed as a state machine;
determining whether or not the counter data is generated based on the state machine;
storing state data, which is transitioned from the counter data, in response to the generation of the counter data; and
outputting the stored state data.

2. The method of claim 1, further comprising:
determining whether or not first counter data, which is a condition for transitioning from a first state data, is generated among the counter data, based on the first state data from among the pieces of state data;
storing second state data, which is transitioned from the first state data, in response to the generation of the first counter data; and
outputting the stored second state data.

3. The method of claim 2, further comprising: in response to the second state data being stored because of the generation of the first counter data,
determining whether or not second counter data, which is a condition for transitioning from the second state data, is generated among the counter data, based on the second state data;
storing third state data, which is transitioned from the second counter data, in response to the generation of the second counter data; and
outputting the stored second state data and the third state data.

4. The method of claim 1, wherein the storing of the state data further comprises storing information on a time point when the state data transitioned by the generation of the counter data, and when the stored data is output, the information on the time point is output.

5. The method of claim 1 further comprising transforming the state machine by determining a predetermined number of state data from among the pieces of state data, as macro state data.

6. The method of claim 5, further comprising:
storing state data transitioned by the generation of counter data in the transformed state machine based on the transformed state machine; and
transforming the macro state data into the predetermined number of state data in response to the macro state data being included in the stored state data.

7. The method of claim 1, further comprising:
transforming the state machine into a first state machine by determining a predetermined number of state data from among the pieces of state data, as first macro state data;
storing state data transitioned by the generation of counter data in the first state machine based on the first state machine;
transforming the state machine into a second state machine by determining another predetermined number of state data from among the pieces of state data, as second macro state data;
storing state data transitioned by the generation of counter data in the second state machine based on the second state machine;
transforming the first macro state data or the second macro state data into the predetermined number of state data or the another predetermined number of state data in response to the first macro state data or the second macro state data being included in the state data stored based on the first state machine and the state data stored based on the second state machine; and
outputting the transformed state data.

8. The method of claim 1, wherein in the storing of the state data, the transitioned state data is stored in order of transition by the generation of the counter data.

9. The method of claim 1, wherein the pieces of state data and the counter data that is a transition condition between the pieces of state data, expressed as the state machine, are determined by a user's setting.

10. A device for processing counter data, the device comprising:
a state information receiver configured to receive pieces of state data and the counter data, which is a transition condition between the pieces of state data, the pieces of state data and the counter data being expressed as a state machine;
a processor, based on the state machine, configured to determine whether or not the counter data is generated;
a state buffer, when the counter data is generated, configured to store state data transitioned by the generation of the counter data; and
an output unit configured to output the stored state data.

11. The device of claim 10, wherein the processor is further configured to determine whether or not first counter data, which is a condition for transitioning from the first state data, is generated among the counter data based on first state data from among the pieces of state data, and
the state buffer is further configured to store second state data, which is transitioned from the first state data by the generation of the first counter data, in response to the generation of the first counter data, and
the output unit is configured to output the stored second state data.

12. The device of claim 11, wherein the processor is further configured to determine, based on the second state data, whether or not second counter data, which is a condition for transitioning from the second state data, is generated among the counter data in response to storing the second state data because of the generation of the first counter data, and
the state buffer is further configured to store third state data, which is transitioned from the second counter data by the generation of the second counter data, in response to the generation of the second counter data, and
the output unit is further configured to output the stored second state data and the third state data.

13. The device of claim 10, wherein the state buffer is further configured to store information on a time point when the state data transitioned by the generation of the counter data, and the output unit outputs the stored information on the time point.

14. The device of claim 10 further comprising a macro state processor configured to transform the state machine by determining a predetermined number of state data from among the pieces of state data, as macro state data.

15. The device of claim 14, wherein the state buffer is further configured to store, based on the transformed state machine, state data transitioned by the generation of counter data in the transformed state machine, and
the macro state processor is further configured to transform the macro state data into the predetermined number of state data in response to the macro state data being included in the stored state data.

16. The device of claim 14, wherein the macro state processor is further configured to transform the state machine into a first state machine by determining a predetermined number of state data from among the pieces of state data, as first macro state data, and to transform the state machine into a second state machine by determining another predetermined number of state data from among the pieces of state data, as a second macro state data, and
the state buffer is further configured to store state data transitioned by the generation of counter data in the first state machine based on the first state machine, and the state buffer is further configured to store state data transitioned by the generation of counter data in the second state machine based on the second state machine, and
the macro state processor is further configured to transform the first macro state data or the second macro state data into the predetermined number of state data or the another predetermined number of state data, in response to the first macro state data or the second macro state data being included in the state data stored based on the first state machine and the state data stored based on the second state machine, and
the output unit is further configured to output the transformed state data.

17. The device of claim 10, wherein the state buffer is further configured to store the transitioned state data in order of transition by the generation of the counter data.

18. The device of claim 10, wherein the pieces of state data and the counter data that is a transition condition between the pieces of state data, expressed as the state machine, are determined by a user's setting.

19. A non-transitory computer readable recording medium having embodied thereon a computer program for executing the method of claim 1.
